(19) United States
(12) Patent Application Publication
(10) Pub. No.: US 2021/0223981 A1
(43) Pub. Date: Jul. 22, 2021

(54) DATA WRITING METHOD, MEMORY CONTROLLING CIRCUIT UNIT AND MEMORY STORAGE DEVICE

(71) Applicant: PHISON ELECTRONICS CORP., Miaoli (TW)

(72) Inventors: Po-Wen Hsiao, Taipei City (TW); Chi-Ting Chen, Taipei City (TW)

(73) Assignee: PHISON ELECTRONICS CORP., Miaoli (TW)

(21) Appl. No.: 16/795,601

(22) Filed: Feb. 20, 2020

(30) Foreign Application Priority Data
Jan. 21, 2020 (TW) 109102096

(51) Int. Cl. G06F 3/06

(52) U.S. Cl. CPC G06F 3/0652; G06F 3/0658; G06F 3/0673; G06F 3/0608; G06F 3/0659

(57) ABSTRACT

A data writing method, a memory controlling circuit unit and a memory storage device are provided. The method includes: receiving data; determining whether the data is compressible; when the data is compressible, writing the data into a first type of the physical erasing units; and when the data is incompressible, writing the data to a second type of the physical erasing units.

### CROSS-REFERENCE TO RELATED APPLICATION

This application claims the priority benefit of Taiwan application serial no. 109102096, filed on Jan. 21, 2020. The entirety of the above-mentioned patent application is hereby incorporated by reference herein and made a part of this specification.

### BACKGROUND

### 1. Technology Field

The invention relates to data writing method, a memory controlling circuit unit, and a memory storage device.

### 2. Description of Related Art

Digital cameras, mobile phones and MP3 players have grown very rapidly in recent years, and accordingly, consumers' demands for storage media have increased rapidly. A rewritable non-volatile memory module (e.g., a flash memory), due to having characteristics, such as data non-volatility, low power consumption, a compact size and no mechanical structure, is suitable for being built in the aforementioned portable multi-media devices listed above.

In general, the rewritable non-volatile memory module includes a plurality of physical erasing units. When data is written into the rewritable non-volatile memory module, the data may usually be written (or stored) into corresponding physical erasing units according to data characteristics, and this procedure may also be referred to as “data diversion”. Nevertheless, how to effectively determine the data characteristics to execute the data diversion so as to enhance efficiency and accuracy of the data diversion is one of the problems to be solved by the technicians skilled in the field.

Nothing herein should be construed as an admission of knowledge in the prior art of any portion of the invention. Furthermore, citation or identification of any document in this application is not an admission that such document is available as prior art to the invention, or that any reference forms a part of the common general knowledge in the art.

### SUMMARY

The invention provides data writing method, a memory controlling circuit unit and a memory storage device capable of enhancing efficiency and accuracy of data diversion.

The invention provides data writing method for a rewritable non-volatile memory module including a plurality of physical erasing units, and the data writing method includes: receiving data; determining whether the data is compressible; when the data is compressible, writing the data into a first type of the physical erasing units among the plurality of physical erasing units; and when the data is incompressible, writing the data into a second type of the physical erasing units among the plurality of physical erasing units.

The invention provides a memory controlling circuit unit for a rewritable non-volatile memory module including a plurality of physical erasing units, and the memory controlling circuit unit includes a host interface, a memory interface and a memory management circuit. The host interface is configured to be coupled to a host system. The memory interface is configured to be coupled to the rewritable non-volatile memory module. The memory management circuit is coupled to the host interface and the memory interface and configured to perform operations including: receiving data; determining whether the data is compressible; when the data is compressible, writing the data into a first type of the physical erasing units among the plurality of physical erasing units; and when the data is incompressible, writing the data into a second type of the physical erasing units among the plurality of physical erasing units.

The invention provides a memory storage device including a connection interface unit, a rewritable non-volatile memory module and a memory controlling circuit unit is provided. The connection interface unit is configured to be coupled to a host system. The rewritable non-volatile memory module includes a plurality of physical erasing units. The memory controlling circuit unit is coupled to the connection interface unit and the rewritable non-volatile memory module, and configured to perform operations including: receiving data; determining whether the data is compressible; when the data is compressible, writing the data into a first type of the physical erasing units among the plurality of physical erasing units; and when the data is incompressible, writing the data into a second type of the physical erasing units among the plurality of physical erasing units.

In an embodiment of the invention, in the operation of determining whether the data is compressible, the memory controlling circuit unit is further configured to perform operations including: compressing the data to obtain compressed data; obtaining a compression ratio corresponding to the data according to the data and the compressed data; and determining whether the data is compressible according to the compression ratio.

To sum up, the data writing method, the memory controlling circuit unit and the memory storage device of the invention can perform the data diversion according to the data, thereby enhancing efficiency and accuracy of the data diversion.

It should be understood, however, that this Summary may not contain all of the aspects and embodiments of the invention, is not meant to be limiting or restrictive in any manner, and that the invention as disclosed herein is and will be understood by those of ordinary skill in the art to encompass obvious improvements and modifications thereto.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a host system, a memory storage device and an input/output (I/O) device according to an exemplary embodiment of the invention.

FIG. 2 is a schematic diagram illustrating a host system, a memory storage device and an I/O device according to another exemplary embodiment of the invention.

FIG. 3 is a schematic diagram illustrating a host system and a memory storage device according to another exemplary embodiment of the invention.

FIG. 4 is a schematic block diagram illustrating a memory storage device according to an exemplary embodiment of the invention.

FIG. 5 is a schematic block diagram illustrating a memory controlling circuit unit according to an exemplary embodiment of the invention.

FIG. 6 and FIG. 7 are exemplary schematic diagrams illustrating examples of the management of the physical erasing units according to an exemplary embodiment.

FIG. 8 is a flowchart of a method of data diversion according to an exemplary embodiment.

FIG. 9 is a flowchart of a method of determining whether data is compressible according to an exemplary embodiment.

FIG. 10 is a flowchart of an integrated data diversion method according to an exemplary embodiment.

FIG. 11 is a flowchart of an integrated data diversion method according to another exemplary embodiment.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the invention may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least on of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

Generally speaking, a memory storage device (also referred to as a memory storage system) includes a rewritable non-volatile memory module and a controller (also referred to as a control circuit). The memory storage device is usually used together with a host system, such that the host system can write data into or read data from the memory storage device.

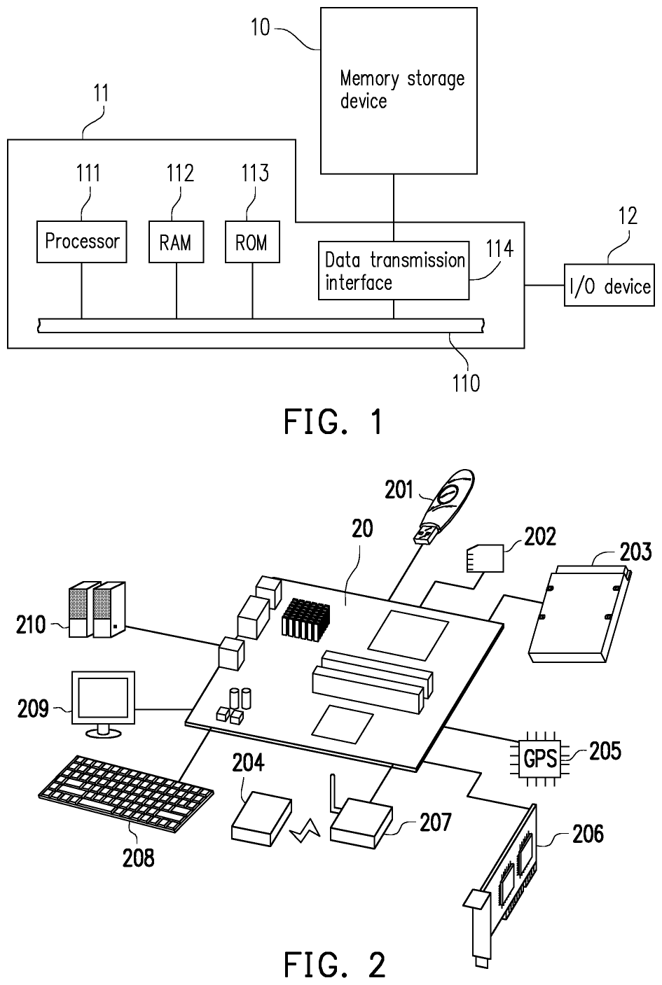

FIG. 1 is a schematic diagram illustrating a host system, a memory storage device and an input/output (I/O) device according to an exemplary embodiment of the invention. FIG. 2 is a schematic diagram illustrating a host system, a memory storage device and an I/O device according to another exemplary embodiment of the invention.

Referring to FIG. 1 and FIG. 2, a host system 11 generally includes a processor 111, a random access memory (RAM) 112, a read only memory (ROM) 113 and a data transmission interface 114. The processor 111, the RAM 112, the ROM 113 and the data transmission interface 114 are all coupled to a system bus 110.

In the present exemplary embodiment, the host system 11 is coupled to the memory storage device 10 through the data transmission interface 114. For example, the host system 11 may store data into or read data from the memory storage device 10 through the data transmission interface 114. In addition, the host system 11 is coupled to an I/O device 12 through the system bus 110. For example, the host system 11 may transmit an output signal to or receive an input signal from the I/O device 12 through the system bus 110.

In the present exemplary embodiment, the processor 111, the RAM 112, the ROM 113 and the data transmission interface 114 may be disposed on a mainboard 20 of the host system 11. The number of the data transmission interfaces 114 may be one or a plurality. The mainboard 20 may be coupled to the memory storage device 10 in a wired or a wireless manner through the data transmission interface 114. The memory storage device 10 may be, for example, a flash drive 201, a memory card 202, or a solid state drive (SSD) 203 or a wireless memory storage device 204. The wireless memory storage device 204 may be, for example, a memory storage device based on a variety of wireless communication techniques, such as a near field communication (NFC) memory storage device, a WiFi memory storage device, a Bluetooth memory storage device or a low energy (LE) Bluetooth memory storage device (e.g., iBeacon). In addition, the mainboard 20 may also be coupled to various I/O devices, such as a global positioning system (GPS) module 205, a network interface card 206, a wireless transmission device 207, a keyboard 208, a monitor 209, a speaker 210 through the system bus 110. For example, in an exemplary embodiment, the mainboard 20 may access the wireless memory storage device 204 through the wireless transmission device 207.

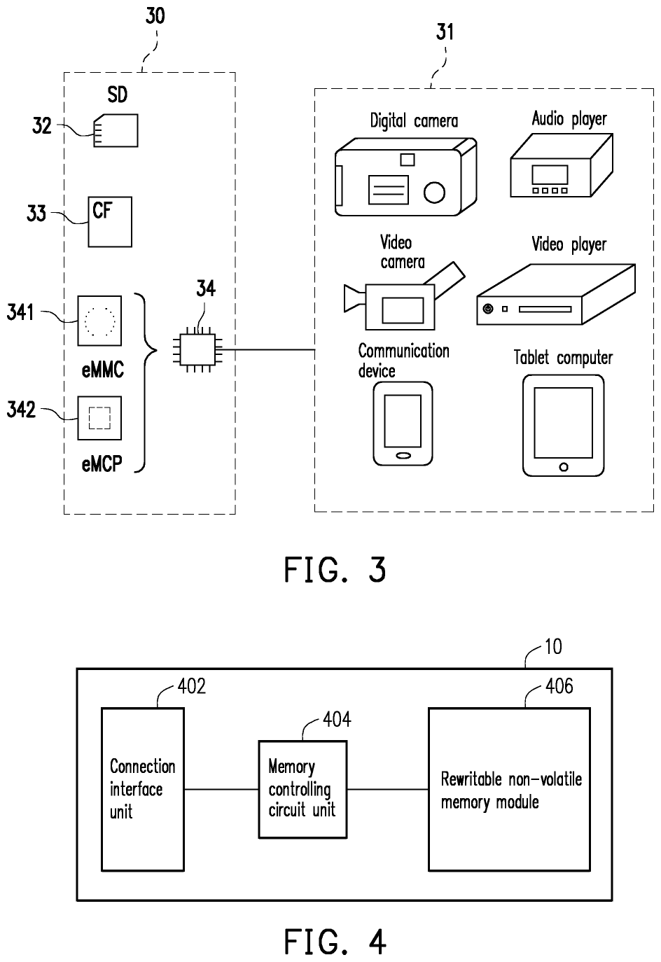

In an exemplary embodiment, the host system as mentioned can substantially be any system collocated with the memory storage device to store data. Though the host system is illustrated as a computer system for description in the exemplary embodiments above, FIG. 3 is a schematic diagram illustrating a host system and a memory storage device according to another exemplary embodiment of the invention. Referring to FIG. 3, in another exemplary embodiment, a host system 31 may also be a system, for example, a digital camera, a video camera, a communication device, an audio player, a video player or a tablet computer, and a memory storage device 30 may be various non-volatile memory storage devices used thereby, for example, an secure digital (SD) card 32, a compact flash (CF) card 33 or an embedded storage device 34. The embedded storage device 34 may include an embedded multi media card (eMMC) 341 and/or an embedded multi chip package (eMCP) storage device 342, in which a memory memory module is directly coupled to a substrate of the host system.

FIG. 4 is a schematic block diagram illustrating a memory storage device according to an exemplary embodiment of the invention.

Referring to FIG. 4, the memory storage device 10 includes a connection interface unit 402, a memory controlling circuit unit 404, and a rewritable non-volatile memory module 406.

The connection interface unit 402 is configured to couple the memory storage device 10 to the host system 11. In the present exemplary embodiment, the connection interface circuit 402 is compatible with a peripheral component interconnect express (PCI express) interface standard and is also compatible with a non-volatile memory express (NVM express) interface standard. Specifically, the NVM express interface standard refers to a protocol for communication between the host system and the memory storage device, which defines a register interface, a command set and a feature set between a controller of the memory storage device and an operating system of the host system and aims to improve a data access speed and a data transmission rate for a PCIe interface-based memory storage device by optimizing the interface standard of the memory storage device. Nevertheless, in another exemplary embodiment, the connection interface unit 402 may also be compatible with other suitable standards. In addition, the connection interface unit 402 and the memory controlling circuit unit 404 may be packaged into one chip, or the connection interface unit 402 is deployed outside of a chip containing the memory controlling circuit unit 404.

The memory controlling circuit unit 404 is configured to execute a plurality of logic gates or control commands which are implemented in a hardware form or a firmware form and perform operations of data writing, data reading or data erasing in the rewritable non-volatile memory storage module 406 according to the commands of the host system 11.

The rewritable non-volatile memory module 406 is coupled to the memory controlling circuit unit 404 and configured to store data written by the host system 11. The rewritable non-volatile memory module 406 may also be a single-level cell (SLC) NAND flash memory module (i.e., a flash memory module capable of storing data of 1 bit in one memory cell), a multi-level cell (MLC) NAND flash memory module (i.e., a flash memory module capable of storing data of 2 bits in one memory cell), a triple-level cell (TLC) NAND flash memory module (i.e., a flash memory module capable of storing data of 3 bits in one memory cell), any other flash memory module, or any other memory module with the same characteristics.

Each memory cell in the rewritable non-volatile memory module 406 stores one or more bits by the changing of a voltage (which is referred to as a threshold voltage hereinafter). Specifically, there is a charge trapping layer between a control gate and a channel of each memory cell. Through applying a writing voltage to the control gate, an amount of electrons in the charge trapping layer may be changed, so as to change the threshold voltage of each memory cell. This process of changing the threshold voltage may also be referred to as “writing data into the memory cell” or “programming the memory cell”. Along with the change of the threshold voltage, each memory cell in the rewritable non-volatile memory module 406 has a plurality of storage states. Which storage state a memory cell belongs to may be determined through applying a reading voltage, so as to obtain the one or more bits stored by the memory cell.

In the present exemplary embodiment, the memory cells of the rewritable non-volatile memory module 406 constitute a plurality of physical programming units, and the physical programming units constitute a plurality of physical erasing units. Specifically, the memory cells on the same word line constitute one or more physical programming units. If each memory cell is capable of storing 2 or more bits, the physical programming units on the same word line may be categorized into a lower and an upper physical programming units. For example, a least significant bit (LSB) of one memory cell belongs to the lower physical programming unit, and a most significant bit (MSB) of one memory cell belongs to the upper physical programming unit. In general, in the MLC NAND flash memory, a writing speed of the lower physical programming unit is faster than a writing speed of the upper physical programming unit, or a reliability of the lower physical programming unit is higher than a reliability of the upper physical programming unit.

In the present exemplary embodiment, a physical programming unit is the smallest unit for programming. Namely, the physical programming unit is the smallest unit for writing data. For example, the physical programming unit is a physical page or a physical sector. If the physical programming unit is the physical page, these physical programming units usually include a data bit area and a redundant bit area. The data bit area includes multiple physical sectors configured to store user data, and the redundant bit area is configured to store system data (e.g., management data such as an error correcting code). In the present exemplary embodiment, the data bit area contains 32 physical sectors, and a size of each physical sector is 512 bytes (B). Nevertheless, in other exemplary embodiments, the data bit area may also contain 8, 16 physical sectors or a greater or smaller number of physical sectors, and the size of each physical sector may also be greater or smaller. On the other hand, a physical erasing unit is the smallest unit for erasing. Namely, each physical erasing unit has the smallest number of memory cells to be erased altogether. For example, the physical erasing unit is a physical block.

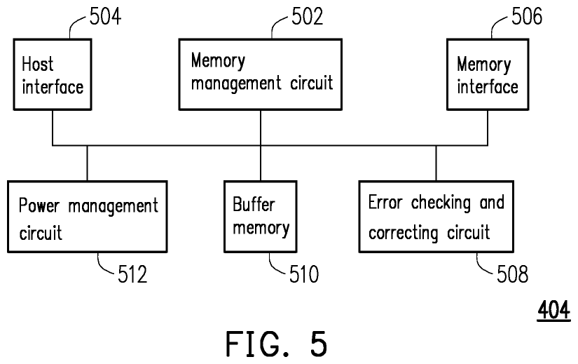

FIG. 5 is a schematic block diagram illustrating a memory controlling circuit unit according to an exemplary embodiment of the invention.

Referring to FIG. 5, the memory controlling circuit unit 404 includes a memory management circuit 502, a host interface 504 and a memory interface 506.

The memory management circuit 502 is configured to control the overall operation of the memory controlling circuit unit 404. Specifically, the memory management circuit 502 has a plurality of control commands, and when the memory storage device 10 is in operation, the control commands are executed to perform operations of data writing, data reading, and data erasing. The operations of the memory management circuit 502 when being described below are similar to the operations of the memory controlling circuit unit 404.

In the present exemplary embodiment, the control commands of the memory management circuit 502 are implemented in a firmware form. For example, the memory management circuit 502 has a microprocessor unit (not shown) and a ROM (not shown), and the control instructions are burnt in the ROM. When the memory storage device 10 is in operation, these control commands are executed by the microprocessor unit to perform operations of data writing, data reading and data erasing.

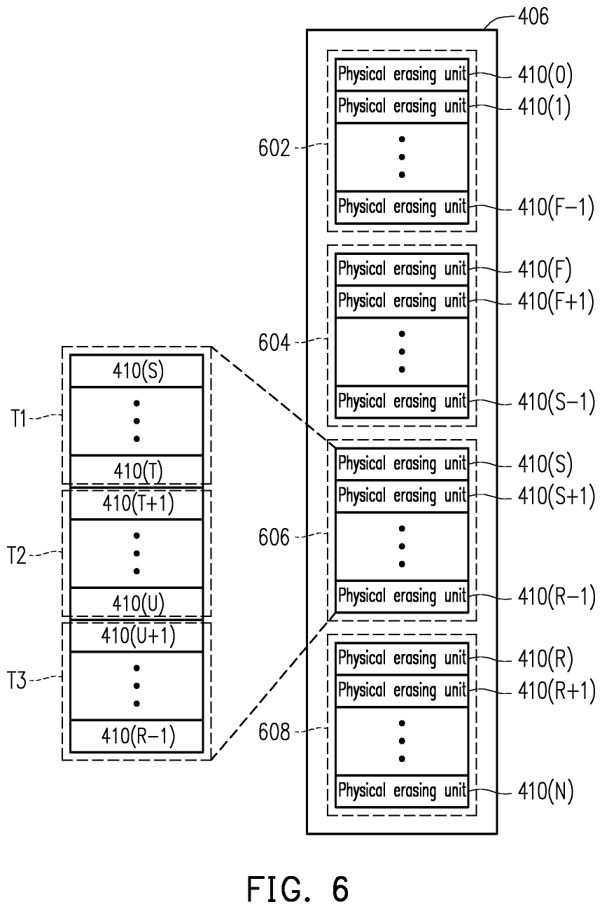

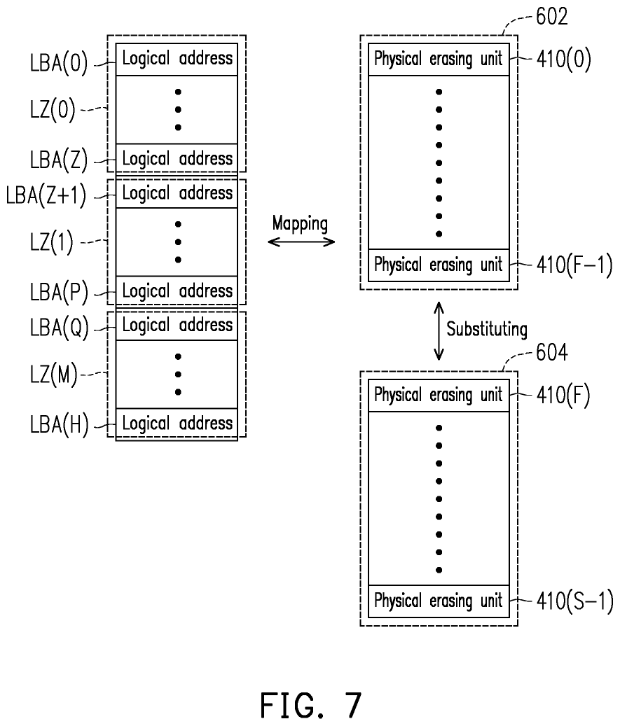

FIG. 6 and FIG. 7 are exemplary schematic diagrams illustrating examples of the management of the physical erasing units according to an exemplary embodiment.

It should be understood that terms, such as “select”, “group”, “divide”, “associate” and so forth, are logical concepts which are used to describe operations in the physical erasing units of the rewritable non-volatile memory module 406. That is to say, the physical erasing units of the rewritable non-volatile memory module are logically operated, but actual positions of the physical erasing units of the rewritable non-volatile memory module are not changed.

Referring to FIG. 6, the memory management circuit 502 logically divides the physical erasing units 410(0) to 410(N) into a data area 602, a spare area 604, a system area 606, and a replacement area 608.

The physical erasing units logically belonging to the data area 602 and the spare area 604 are configured to store data from the host system 11. Specifically, the physical erasing units of the data area 602 are the physical erasing units which have been used for storing data, and the physical erasing units of the spare area 604 are the physical erasing units which are used for replacing the physical erasing units of the data area 602. In other words, when a write command and data to be written are received from the host system 11, the memory management circuit 502 selects a physical erasing unit from the spare area 604 and writes the data into the selected physical erasing unit to replace a physical erasing unit of the data area 602. In the present embodiment, the rewritable non-volatile memory module 406 may include various types of physical erasing units, and each of the physical erasing units 410(0) to 410(N) is one of the aforementioned types. For example, taking the spare area 604 as an example, the physical erasing units 410(S) to 410(T) belong to a first type T1 of the physical erasing units, the physical erasing units 410(T+1) to 410(U) belong to a second type T2 of the physical erasing units, and the physical erasing units 410(U+1) to 410(R-1) belong to a third type T3 of the physical erasing units. In the present embodiment, the first type of the physical erasing units are, for example, physical erasing units constituted by single level cells (SLCs), and the second type of the physical erasing units and the third type of the physical erasing units are, for example, physical erasing units constituted by multiple level cells (MLCs) or triple level cells (TLCs), but the invention is not employed to limit the types of the physical erasing units. In other embodiments, the first type of the physical erasing units, the second type of the physical erasing units and the third type of the physical erasing units may also refer to the physical erasing units that respectively perform writing by using different programming modes (e.g., a single-page programming mode or a multi-page programming mode). In addition, the invention is not employed to limit the number of the types of the physical erasing units in the rewritable non-volatile memory module 406.

The physical erasing units logically belonging to the data area 606 are configured to record system data. For example, the system data includes the manufacturers and models of the rewritable non-volatile memory module, the number of physical erasing units in the rewritable non-volatile memory module, the number of physical programming units in each physical erasing unit, and so on.

The physical erasing units logically belonging to the replacement area 608 are used in a bad physical erasing unit replacement procedure for replacing damaged physical erasing units. Specifically, if there are still normal physical erasing units in the replacement area 608 and a physical erasing unit in the data area 602 is damaged, the memory management circuit 502 selects a normal physical erasing unit from the replacement area 608 to replace the damaged physical erasing unit.

In particular, the numbers of the physical erasing units in the data area 602, the spare area 604, the system area 606 and the replacement area 608 vary with different memory module standards. In addition, it should be understood that the grouping relations for associating the physical erasing units with the data area 602, the spare area 604, the system area 606 and the replacement area 608 are dynamically changed in the operations of the memory storage device 10. For example, when a physical erasing unit in the spare area 604 is damaged and replaced by a physical erasing unit in the replacement area 608, the physical erasing unit which is previously in the replacement area 608 is associated with the spare area 604.

Referring to FIG. 7, the memory management circuit 502 configures logical addresses LBA(0) to LBA(H) for mapping the physical erasing units of the data area 602, in which each logical address has a plurality of logical units for mapping the physical programming units of the corresponding physical erasing unit. Meanwhile, when the host system 11 is to write data into a logical address or update data stored in the logical address, the memory management circuit 502 selects a physical erasing unit from the spare area 604 as an operational physical erasing unit for writing the data to substitute for the physical erasing unit of the data area 602. Additionally, when the physical erasing unit employed as the operational physical erasing unit is fully written, the memory controlling circuit unit 404 (or the memory management circuit 502) again selects an empty physical erasing unit from the spare area 604 as an operational physical erasing unit, so as to continue writing the update data corresponding to the write command from the host system 11. In addition, when the number of the physical erasing units available in the spare area 604 is less than a preset value, the memory controlling circuit unit 404 (or the memory management circuit 502) performs a valid data merge operation (also referred to as a garbage collection operation) to manage valid data in the data area 602, so as to re-associate the physical erasing units in the data area 602 in which no valid data is stored with the spare area 604.

In order to identify which physical erasing unit the data of each logical address is stored, in the present exemplary embodiment, the memory management circuit 502 records the mapping between the logical addresses and the physical erasing units. For example, in the present exemplary embodiment, the memory management circuit 502 stores a logical-physical mapping table in the rewritable non-volatile memory module 406 to record the physical erasing unit that each logical address is mapped to. The memory management circuit 502, when being to access the data, loads the logical-physical address mapping table into a buffer memory for maintenance and writes or reads the data according to the logical-physical mapping table.

It is to be mentioned that the buffer memory is incapable of storing all mapping tables recording the mapping relations for all the logical addresses due to its limited capacity. Thus, in the present exemplary embodiment, the memory management circuit 502 groups the logical addresses LBA(0) to LBA(H) into a plurality of logical zones LZ(0) to LZ(M) and configures a logical-physical mapping table for each logical zone. Specially, when the memory management circuit 502 is to update the mapping with respect to a certain logical address, the logical-physical mapping table corresponding to this logical address is loaded into the buffer memory to be updated.

In another exemplary embodiment, the control commands of the memory management circuit 502 may also be stored as program codes in a specific area (e.g., a system area in the memory module exclusively used for storing the system data) of the rewritable non-volatile memory module 406. In addition, the memory management circuit 502 has a microprocessor unit (not shown), an ROM (not shown) and an RAM (not shown). Specially, the read-only memory has a boot code, and when the memory circuit unit 404 is enabled, the microprocessor unit first executes the boot code to load the control commands stored in the rewritable non-volatile memory module 406 into the RAM of the memory management circuit 502. Thereafter, the microprocessor unit executes the control commands to perform the operations of data writing, data reading and data erasing.

In addition, in another exemplary embodiment, the control commands of the memory management circuit 502 may be implemented in a hardware form. For example, the memory management circuit 502 includes a microcontroller, a memory cell management circuit, a memory writing circuit, a memory reading circuit, a memory erasing circuit and a data processing circuit. The memory cell management circuit, the memory writing circuit, the memory reading circuit, the memory erasing circuit and the data processing circuit are coupled to the microcontroller. The memory cell management circuit is configured to manage memory cells of the rewritable non-volatile memory module 406 or groups thereof. The memory writing circuit is configured to issue a write command sequence to the rewritable non-volatile memory module 406 to write data into the rewritable non-volatile memory module 406. The memory reading circuit is configured to issue a read command sequence to the rewritable non-volatile memory module 406 to read data from the rewritable non-volatile memory module 406. The memory erasing circuit is configured to issue an erase command sequence to the rewritable non-volatile memory module 406 to erase data from the rewritable non-volatile memory module 406. The data processing circuit is configured to process data to be written into the rewritable non-volatile memory module 406 or data read from the rewritable non-volatile memory module 406. Each of the write command sequence, the read command sequence and the erase command sequence may include one or a plurality of program codes or command codes and may be configured to instruct the rewritable non-volatile memory module 406 to perform corresponding writing, reading and erasing operations. In an exemplary embodiment, the memory management circuit 502 may also issue other types of command sequences to the rewritable non-volatile memory module 406 to instruct the rewritable non-volatile memory module 406 to perform corresponding operations.

Referring to FIG. 5 again, the host interface 504 is coupled to the memory management circuit 502 and configured to receive and identify commands and data transmitted by the host system 11. That is to say, the commands and the data transmitted by the host system 11 are transmitted to the memory management circuit 502 through the host interface 504. In the present exemplary embodiment, the host interface 504 complies with the PCI Express standard. Nevertheless, it should be understood that the invention is not limited thereto, and the host interface 504 may also comply with the PATA standard, the IEEE 1394 standard, the SATA standard, the USB standard, the SD standard, the UHS-I standard, the UHS-II standard, the MS standard, the MMC standard, the eMMC standard, the UFS standard, the CF standard, the IDE standard, or other suitable standards for data transmission.

The memory interface 506 is coupled to the memory management circuit 502 and configured to access the rewritable non-volatile memory module 406. In other words, the data to be written into the rewritable non-volatile memory module 406 is converted to an acceptable format for the rewritable non-volatile memory module 406 through the memory interface 506. Specifically, if the memory management circuit 502 is to access the rewritable non-volatile memory module 406, the memory interface 506 transmits corresponding command sequences. For example, the command sequences may include a write command sequence which instructs to write data, a read command sequence which instructs to read data, an erase command sequence which instructs to erase data and other command sequences for correspondingly instructing various memory operations (for example, changing a read voltage level, executing the garbage collection operation, or the like). These command sequences, for example, are generated by the memory management circuit 502 and transmitted to the rewritable non-volatile memory module 406 through the memory interface 506. These command sequences may include one or more signals or data on the bus. The signals or data may include command codes or program codes. For example, a read command sequence may include information, such as a read identification code, a memory address and so on.

In an exemplary embodiment, the memory controlling circuit unit 404 further includes an error checking and correcting circuit 508, a buffer memory 510 and a power management circuit 512.

The error checking and correcting circuit 508 is coupled to the memory management circuit 502 and configured to perform an error checking and correcting operation to ensure data accuracy. Specifically, when the memory management circuit 502 receives a write command from the host system 11, the error checking and correcting circuit 508 may generate a corresponding error correcting code (ECC) and/or an error detecting code (EDC) for data corresponding to the write command, and the memory management circuit 502 may write the data corresponding to the write command and the corresponding ECC and/or EDC to the rewritable non-volatile memory module 406. Subsequently, the memory management circuit 502 may read the ECC and/or the EDC corresponding to the data simultaneously when reading the data from the rewritable non-volatile memory module 406, and the error checking and correcting circuit 508 may perform the error checking and correcting operation on the read data according to the ECC and/or EDC.

The buffer memory 510 is coupled to the memory management circuit 502 and configured to temporarily store data and commands from the host system 11 or data from the rewritable non-volatile memory module 406. The power management circuit 512 is coupled to the memory management circuit 502 and configured to control the power of the memory storage device 10.

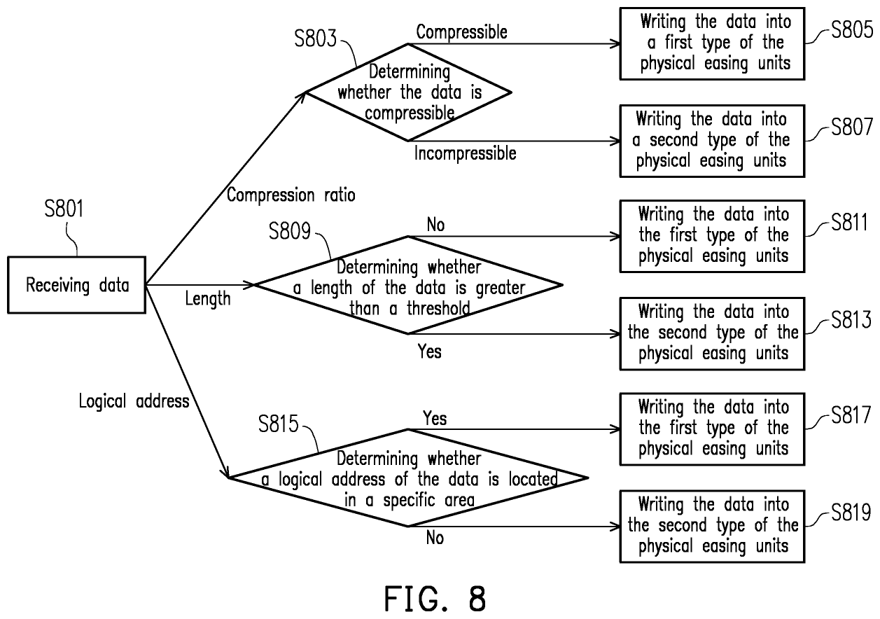

FIG. 8 is a flowchart of a method of data diversion according to an exemplary embodiment.

Referring to FIG. 8, in step S801, the memory management circuit 502 receives data from the host system 11. Thereafter, the memory management circuit 502 performs data diversion according to a compression ratio, a length or a logical address of the data.

Taking the compression ratio for example, in step S803, the memory management circuit 502 determines whether the data is compressible, and the method of determining whether the data is compressible will be described in detail below. When the data is compressible, in step S805, the memory cell management circuit 502 writes the data into a first type of the physical erasing units in the rewritable non-volatile memory module 406. When the data is incompressible, in step S807, the memory cell management circuit 502 writes the data into a second type of the physical erasing units in the rewritable non-volatile memory module 406.

It should be mentioned that the aforementioned incompressible data includes, for example, multi-media streaming data, and the compressible data includes, for example, non-streaming data. Nevertheless, the invention is not employed to limit the types of the incompressible data and the compressible data. In addition, the physical erasing units in the rewritable non-volatile memory module 406, for example, may be categorized into various types. The first type of the physical erasing units are, for example, the physical erasing units in the rewritable non-volatile memory module 406 which are exclusively employed to store the compressible data, and the second type of the physical erasing units are, for example, the physical erasing units in the rewritable non-volatile memory module 406 which are exclusively employed to store the incompressible data. Nevertheless, the invention is not employed to limit the types that the first type of the physical erasing units and the second type of the physical erasing units belong to. In other embodiments, the first type of the physical erasing units and the second type of the physical erasing units may be the physical erasing units respectively configured to store data with different properties.

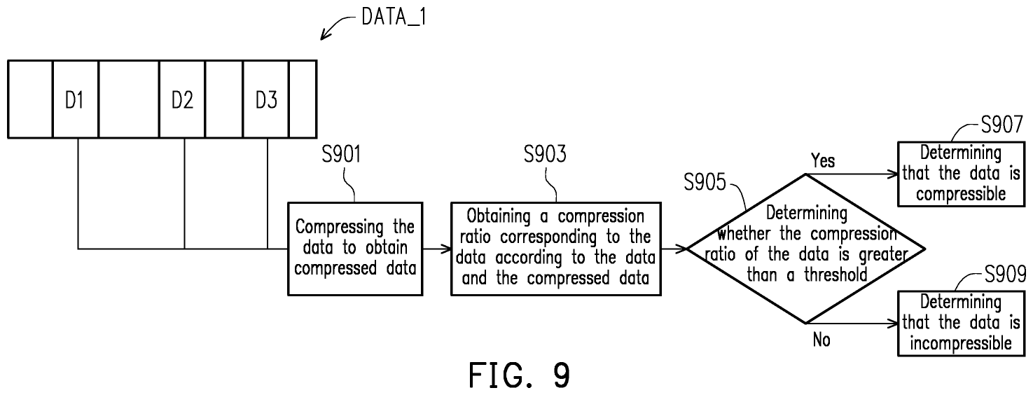

FIG. 9 is a flowchart of a method of determining whether data is compressible according to an exemplary embodiment.

Referring to FIG. 9, the detailed flow of step S803 may be as shown in FIG. 9. In detail, it is assumed that data DATA_1 is the data received from the host system 11 in step S801. The memory management circuit 502 may compress a part of or all of the data DATA_1 to calculate a compression ratio corresponding to the data DATA_1. In the example illustrated in FIG. 9, the memory management circuit 502 may sample data D1 through D3 from the data DATA_1. Thereafter, in step S901, the memory management circuit 502 compress the data D1 through D3 to obtain compressed data. In step S903, the memory management circuit 502 obtains compression ratios corresponding to the data D1 through D3 according to the data D1 through D3 and the compressed data. For example, the memory management circuit 502 may obtain the aforementioned compression ratio by dividing a sum of sizes of the data D1 through D3 by a size of the compressed data. Thereafter, the memory management circuit 502 may determine whether the data DATA_1 is compressible according to the compression ratio.

More specifically, in step S905, the memory management circuit 502 determines whether the compression ratio is greater than a threshold, but the invention is not employed to limit the value of the threshold. When the compression ratio is greater than the threshold, in step S907, the memory management circuit 502 determines that the data DATA_1 is compressible. When the compression ratio is not greater than the threshold, in step S909, the memory management circuit 502 determines that the data DATA_1 is incompressible.

Referring to FIG. 9 again, the memory management circuit 502 may also perform the data diversion according to a length of the data. In detail, in step S809, the memory management circuit 502 determines whether a length of the data received in step S801 is greater than a threshold, but the invention is not employed to limit the value of the threshold. When the length of the data is not greater than the threshold, in step S811, the memory cell management circuit 502 writes the data into the first type of the physical erasing units in the rewritable non-volatile memory module 406. When the length of the data is greater than the threshold, in step S813, the memory cell management circuit 502 writes the data into the second type of the physical erasing units in the rewritable non-volatile memory module 406.

In addition, the memory management circuit 502 may also perform the data diversion according to a logical address of the data. In detail, in step S815, the memory management circuit 502 determines whether a logical address of the data is located in a specific area (for example, a certain logical address range), but the invention is not employed to limit the logical address range of the specific area. When the logical address of the data is located in the specific area, in step S817, the memory cell management circuit 502 writes the data into the first type of the physical erasing units in the rewritable non-volatile memory module 406. When the logical address of the data is not located in the specific area, in step S819, the memory cell management circuit 502 writes the data into the second type of the physical erasing units in the rewritable non-volatile memory module 406.

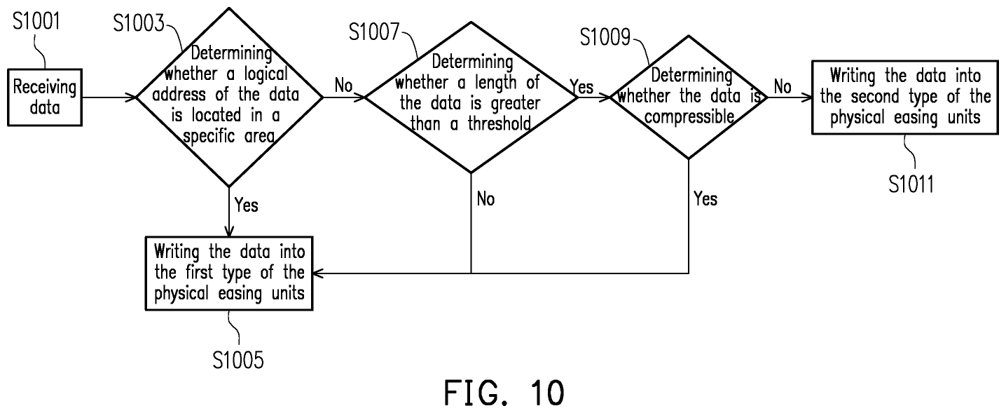

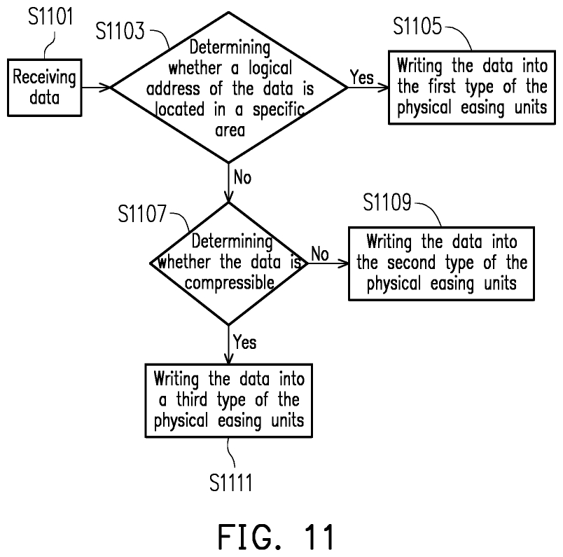

It should be noted that in the example illustrated in FIG. 8, the memory management circuit 502 performs the data diversion according to the compression ratio, the length or the logical address of the data. In other words, the three methods of the data diversion illustrated in FIG. 8 are independent of one another. However, in other embodiments, the three methods of the data diversion illustrated in FIG. 8 may be integrated. For example, FIG. 10 is a flowchart of an integrated data diversion method according to an exemplary embodiment.

Referring to FIG. 10, in step S1001, the memory management circuit 502 receives data from the host system 11. In step S1003, whether a logical address of the data is located in the aforementioned specific area is determined. When the logical address of the data is located in the specific area, in step S1005, the memory management circuit 502 writes the data into the first type of the physical erasing units. Nevertheless, when the logical address of the data is not located in the specific area, in step S1007, the memory management circuit 502 determines whether a length of the data is greater than a threshold. When the length of the data is not greater than the threshold, the memory management circuit 502 performs step S1005 to write the data into the first type of the physical erasing units. When the length of the data is greater than the threshold, in step S1009, the memory management circuit 502 determines whether the data is compressible. When the data is compressible, the memory management circuit 502 performs step S1005 to write the data into the first type of the physical erasing units. When the data is incompressible, in step S1011, the memory management circuit 502 writes the data into the second type of the physical erasing units. It should be noted that in other embodiments, the memory management circuit 502 writes the data into the second type of the physical erasing units only when the length of the data is not greater than the threshold and the data is compressible.

That is to say, in the process illustrated in FIG. 10, the memory management circuit 502 performs step S1009 to determine whether the data is compressible only when the logical address of the data is not located in the specific area and the length of the data is greater than the threshold. In addition, when the logical address of the data is located in the specific area or the length of the data is not greater than the threshold, the memory management circuit 502 performs step S1005 to write the data into the first type of the physical erasing units.

Specially, in the process illustrated in FIG. 10, whether the logical address is located in the specific area is determined before whether the length of the data is greater than the threshold is determined. However, in other embodiments, the memory management circuit 502 may also determine whether the length of the data is greater than the threshold is before determining whether the logical address is located in the specific area. For example, when receiving the data from the host system 11, the memory management circuit 502 may first determine whether the length of the data is greater than the threshold. When the length of the data is not greater than the threshold, the memory management circuit 502 may write the data into the first type of the physical erasing units. When the length of the data is greater than the threshold, the memory management circuit 502 may determine whether the logical address of the data is located in the aforementioned specific area. When the logical address of the data is located in the specific area, the memory management circuit 502 may write the data into the first type of the physical erasing units. Nevertheless, the memory management circuit 502 determines whether the data is compressible only when the logical address of the data is not located in the specific area. When the data is compressible, the memory management circuit 502 may write the data into the first type of the physical erasing units. When the data is incompressible, the memory management circuit 502 writes the data into the second type of the physical erasing units.

FIG. 11 is a flowchart of an integrated data diversion method according to another exemplary embodiment.

Referring to FIG. 11, data is received in step S1101. In step S1103, the memory management circuit 502 determines whether a logical address of the data is located in a specific area. When the logical address of the data is located in the specific area, in step S1105, the memory management circuit 502 writes the data into the first type of the physical erasing units.

Nevertheless, in step S1103 as set forth above, when the logical address of the data is not located in the specific area, and in step S1107, the memory management circuit 502 determines whether the data is compressible. If the data is incompressible, in step S1109, the memory management circuit 502 writes the data into the second type of the physical erasing units. If the data is compressible, in step S1111, the memory management circuit 502 writes the data into a third type of the physical erasing units.

In light of the foregoing, the data writing method, the memory controlling circuit unit and the memory storage device of the invention can perform the data diversion according to whether the data is compressible, thereby enhancing efficiency and accuracy of the data diversion. The previously described exemplary embodiments of the invention have the advantages aforementioned, wherein the advantages aforementioned not required in all versions of the invention.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A data writing method, for a rewritable non-volatile memory module comprising a plurality of physical erasing units, comprising:
receiving data;
determining whether the data is compressible;
when the data is compressible, writing the data into a first type of the physical erasing units among the plurality of physical erasing units; and
when the data is incompressible, writing the data into a second type of the physical erasing units among the plurality of physical erasing units.

2. The data writing method according to claim 1, wherein the step of determining whether the data is compressible comprises:
compressing the data to obtain compressed data;
obtaining a compression ratio corresponding to the data according to the data and the compressed data; and
determining whether the data is compressible according to the compression ratio.

3. The data writing method according to claim 2, wherein the step of determining whether the data is compressible according to the compression ratio comprises:
determining whether the compression ratio is greater than a threshold;
when the compression ratio is greater than the threshold, determining that the data is compressible; and
when the compression ratio is not greater than the threshold, determining that the data is incompressible.

4. The data writing method according to claim 1, further comprising:
determining whether a length of the data is greater than a threshold;
when the length of the data is greater than the threshold and the data is incompressible, writing the data into the second type of the physical erasing units; and
when the length of the data is not greater than the threshold and the data is compressible, writing the data into the first type of the physical erasing units.

5. The data writing method according to claim 1, further comprising:
determining whether a logical address of the data is located in a specific area;
when the logical address of the data is located in the specific area and the data is compressible, writing the data into the first type of the physical erasing units among the plurality of physical erasing units;
when the logical address of the data is not located in the specific area and the data is compressible, writing the data into a third type of the physical erasing units; and
when the logical address of the data is not located in the specific area and the data is incompressible, writing the data into the second type of the physical erasing units.

6. The data writing method according to claim 1, wherein before the step of determining whether the data is compressible, the method further comprises:
performing the step of determining whether the data is compressible only when the logical address of the data is not located in the specific area and a length of the data is greater than a threshold.

7. The data writing method according to claim 6, further comprising:
when the logical address of the data is located in the specific area or the length of the data is not greater than the threshold, performing the step of writing the data into the first type of the physical erasing units among the plurality of physical erasing units.

8. A memory controlling circuit unit, for a rewritable non-volatile memory module comprising a plurality of physical erasing units, comprising:
a host interface, configured to be coupled to a host system;
a memory interface, configured to be coupled to the rewritable non-volatile memory module; and
a memory management circuit, coupled to the host interface and the memory interface,
wherein the memory management circuit is configured to receive data,
wherein the memory management circuit is further configured to determine whether the data is compressible,
when the data is compressible, the memory management circuit is further configured to write the data into a first type of the physical erasing units among the plurality of physical erasing units, and
when the data is incompressible, the memory management circuit is further configured to write the data into a second type of the physical erasing units among the plurality of physical erasing units.

9. The memory controlling circuit unit according to claim 8, wherein in the operation of determining whether the data is compressible,
the memory management circuit is further configured to compress the data to obtain compressed data,
the memory management circuit is further configured to obtain a compression ratio corresponding to the data according to the data and the compressed data, and
the memory management circuit is further configured to determine whether the data is compressible according to the compression ratio.

10. The memory controlling circuit unit according to claim 9, wherein in the operation of determining whether the data is compressible according to the compression ratio,
the memory management circuit is further configured to determine whether the compression ratio is greater than a threshold,
when the compression ratio is greater than the threshold, the memory management circuit is further configured to determine that the data is compressible, and
when the compression ratio is not greater than the threshold, the memory management circuit is further configured to determine that the data is incompressible.

11. The memory controlling circuit unit according to claim 8, wherein
the memory management circuit is further configured to determine whether a length of the data is greater than a threshold,
when the length of the data is greater than the threshold and the data is incompressible, the memory management circuit is further configured to write the data into the second type of the physical erasing units, and
when the length of the data is not greater than the threshold and the data is compressible, the memory management circuit is further configured to write the data into the first type of the physical erasing units.

12. The memory controlling circuit unit according to claim 8, wherein
the memory management circuit is further configured to determine whether a logical address of the data is located in a specific area,
when the logical address of the data is located in the specific area and the data is compressible, the memory management circuit is further configured to write the data into the first type of the physical erasing units among the plurality of physical erasing units,
when the logical address of the data is not located in the specific area and the data is compressible, the memory management circuit is further configured to write the data into a third type of the physical erasing units, and
when the logical address of the data is not located in the specific area and the data is incompressible, the memory management circuit is further configured to write the data into the second type of the physical erasing units.

13. The memory controlling circuit unit according to claim 8, wherein before the operation of determining whether the data is compressible,
the memory management circuit is further configured to perform the operation of determining whether the data is compressible only when the logical address of the data is not located in the specific area and a length of the data is greater than a threshold.

14. The memory controlling circuit unit according to claim 13, wherein
when the logical address of the data is located in the specific area or the length of the data is not greater than the threshold, the memory management circuit is further configured to perform the operation of writing the data into the first type of the physical erasing units among the plurality of physical erasing units.

15. A memory storage device, comprising:
a connection interface unit, configured to be coupled to a host system;
a rewritable non-volatile memory module, comprising a plurality of physical erasing units; and
a memory controlling circuit unit, coupled to the connection interface unit and the rewritable non-volatile memory module,
wherein the memory controlling circuit unit is configured to receive data,
wherein the memory controlling circuit unit is further configured to determine whether the data is compressible,
when the data is compressible, the memory controlling circuit unit is further configured to write the data into a first type of the physical erasing units among the plurality of physical erasing units, and
when the data is incompressible, the memory controlling circuit unit is further configured to write the data into a second type of the physical erasing units among the plurality of physical erasing unit.

16. The memory storage device according to claim 15, wherein in the operation of determining whether the data is compressible,
the memory controlling circuit unit is further configured to compress the data to obtain compressed data,
the memory controlling circuit unit is further configured to obtain a compression ratio corresponding to the data according to the data and the compressed data, and
the memory controlling circuit unit is further configured to determine whether the data is compressible according to the compression ratio.

17. The memory storage device according to claim 16, wherein in the operation of determining whether the data is compressible according to the compression ratio,
the memory controlling circuit unit is further configured to determine whether the compression ratio is greater than a threshold,
when the compression ratio is greater than the threshold, the memory controlling circuit unit is further configured to determine that the data is compressible, and
when the compression ratio is not greater than the threshold, the memory controlling circuit unit is further configured to determine that the data is incompressible.

18. The memory storage device according to claim 15, wherein
the memory controlling circuit unit is further configured to determine whether a length of the data is greater than a threshold,
when the length of the data is greater than the threshold and the data is incompressible, the memory controlling circuit unit is further configured to write the data into the second type of the physical erasing units, and
when the length of the data is not greater than the threshold and the data is compressible, the memory controlling circuit unit is further configured to write the data into the first type of the physical erasing units.

19. The memory storage device according to claim 15, wherein
the memory management circuit is further configured to determine whether a logical address of the data is located in a specific area,
when the logical address of the data is located in the specific area and the data is compressible, the memory controlling circuit unit is further configured to write the data into the first type of the physical erasing units among the plurality of physical erasing units,
when the logical address of the data is not located in the specific area and the data is compressible, the memory controlling circuit unit is further configured to write the data into a third type of the physical erasing units, and
when the logical address of the data is not located in the specific area and the data is incompressible, the memory controlling circuit unit is further configured to write the data into the second type of the physical erasing units.

20. The memory storage device according to claim 15, wherein before the operation of determining whether the data is compressible,
the memory controlling circuit unit is further configured to perform the operation of determining whether the data is compressible only when the logical address of the data is not located in the specific area and a length of the data is greater than a threshold.

21. The memory storage device according to claim 20, wherein
when the logical address of the data is located in the specific area or the length of the data is not greater than the threshold, the memory controlling circuit unit is further configured to write the data into the first type of the physical erasing units among the plurality of physical erasing units.
